(19) United States
(12) Patent Application Publication
(10) Pub. No.: US 2016/0204494 A1
(43) Pub. Date: Jul. 14, 2016

(54) 3D MULTILAYER HIGH FREQUENCY SIGNAL LINE

(71) Applicant: Microsoft Technology Licensing, LLC, Redmond, WA (US)

(72) Inventors: Lasse Pykäri, Salo (FI); Pekka J. Mikkola, Salo (FI)

(21) Appl. No.: 14/592,062

(22) Filed: Jan. 8, 2015

(51) Int. Cl. H01P 3/08; H01P 11/00

(52) U.S. Cl. CPC H01P 3/02; H01P 11/001

(57) ABSTRACT

In one example, a manufacturing method is disclosed. There is being dispensed a first dielectric layer on a ground layer. The first dielectric layer is dispensed on a three dimensional portion of a body of an apparatus configured to high frequency signals. There is being jet printed at least one signal line directly on the first dielectric layer. The at least one signal line is configured to the high frequency signals. There is being dispensed a second dielectric layer to encapsulate the at least one signal line. There is being dispensed a conductive layer on the second dielectric layer and partly on the first dielectric layer so that the conductive layer is connected to the ground layer in order to encapsulate both the first dielectric layer and the second dielectric layer. Other examples relate to a shielded multilayer high frequency signal line structure, and a mobile apparatus comprising the shielded multilayer high frequency signal line structure.

### BACKGROUND

A mobile apparatus such as a mobile phone, a phablet, even a tablet, is filled with electronics inside the apparatus. A trend is to make thinner, smaller, however yet more powerful and versatile mobile apparatuses. As a consequence, a physical space inside the mobile apparatus is very limited. Everything needs to be squeezed to a compress entity. Consequently, a printed wiring board, PWB, is very much occupied with electronics. There is not much any excessive space on the PWB. Different components of the mobile apparatus have been separately connected on signal lines running on the PWB. Additionally, radio frequency, RF, signal lines have been designed and implemented using coaxial cable and flexible circuits. For example, a coaxial cable is used to connect two distinct ends of the electronics components to each other, even by using a small cable running inside the mobile apparatus.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

In one example, a manufacturing method is disclosed. There is being dispensed a first dielectric layer on a ground layer. The first dielectric layer is dispensed on a three dimensional portion of a body of an apparatus configured to high frequency signals. There is being jet printed at least one signal line directly on the first dielectric layer. The at least one signal line is configured to the high frequency signals. There is being dispensed a second dielectric layer to encapsulate the at least one signal line. There is being dispensed a conductive layer on the second dielectric layer and partly on the first dielectric layer so that the conductive layer is connected to the ground layer in order to encapsulate both the first dielectric layer and the second dielectric layer.

Other examples relate to a shielded multilayer high frequency signal line structure, and a mobile apparatus comprising the shielded multilayer high frequency signal line structure.

Many of the attendant features will be more readily appreciated as they become better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 illustrates a body of the mobile apparatus having a signal line, in accordance with an illustrative example;

FIG. 2 illustrates a cross section of a multilayer signal line structure, in accordance with an illustrative example;

FIG. 3 illustrates a connection of the signal line, in accordance with an illustrative example;

FIG. 4 illustrates a manufacturing process, in accordance with an illustrative example;

FIG. 5 illustrates a manufacturing process, in accordance with an illustrative example;

FIG. 6 illustrates a manufacturing process, in accordance with an illustrative example;

FIG. 7 illustrates a manufacturing process, in accordance with an illustrative example;

FIG. 8 illustrates a manufacturing process, in accordance with an illustrative example;

FIG. 9 illustrates a manufacturing process, in accordance with an illustrative example;

FIG. 10 illustrates a manufacturing process, in accordance with an illustrative example;

FIG. 11 illustrates a manufacturing process, in accordance with an illustrative example;

FIG. 12 illustrates a manufacturing process, in accordance with an illustrative example;

FIG. 13 illustrates a manufacturing process, in accordance with an illustrative example; and

FIG. 14 illustrates a cross section of dimensions of the multilayer signal line structure, in accordance with an illustrative example.

Like reference numerals are used to designate like parts in the accompanying drawings.

### DETAILED DESCRIPTION

The detailed description provided below in connection with the appended drawings is intended as a description of the present examples and is not intended to represent the only forms in which the present example may be constructed or utilized. However, the same or equivalent functions and sequences may be accomplished by different examples.

Although the present examples may be described and illustrated herein as being implemented in a smartphone or a mobile phone, these are only examples of an apparatus configured to high frequency signals and not a limitation. As those skilled in the art will appreciate, the present examples are suitable for application in a variety of different types of apparatuses, for example, in tablets, phablets, computers, cameras, game consoles, small laptop computers, etc.

An example relates to utilizing materials and manufacturing methods for printing and/or jet printing, for example aerosol jet printing or ink jet printing, multilayer high frequency signal line structure directly on a three dimensional part of the body of the mobile apparatus. For example, the RF signal line structure can be printed and/or jet printed directly to the product mechanics or the cover of the mobile apparatus. Traditionally, high frequency, for example RF, signal lines have been designed and implemented so that coaxial cables and flexible circuits, FPC has been used. Using the multilayer structure, for example conductive and dielectric materials and layers, the signal lines can be designed to meet the technical specifications and to avoid electrical interferences. In an example, the whole structure is relatively thin, for example total height may be less than 500 μm. The layout can be designed directly to smart phone's plastic or metallic cover, for example to the unibody of the mobile.

Consequently, electrical high frequency signal lines and contacts may be manufactured directly to the unibody metal or plastic parts. Manufacturing may be based at least partly on using jet printing manufacturing methods. Shielded multilayer signal lines and SMD components can be assembled to the same structure. An integrated and miniaturized shielded multilayer signal line structure for high frequency signals can be achieved with competitive cost. An example may enable more flexible product architecture of the mobile apparatus. Contact points for the RF signals and other electronics may be designed in a more flexible way. Connection to the PWB may be connected by using, for example spring contacts such as C-clips, which are soldered on the PWB. An example may eliminate a need of coaxial cables, flexible circuits and connectors needed for RF signals. An example may provide flexible design, because three dimensional multilayer high frequency signal line structure, or structures, conforming to the three dimensional shape of the product mechanics, can be manufactured.

Several material deposition phases are used together with material curing, or drying, processes, which are required between the deposition phases. In case of plastic, or similar composition, is used as the body, a curing or deposition process temperatures needs to be lower than a deformation point of the plastics. This avoids overheating, which might cause visual changes to the plastic parts.

An example may impact to the product design of the mobile apparatus. Thinner product may be achieved, as coaxial transmission lines can be integrated into mechanics. Integrated transmission line loss per line length is almost as low as the loss of the coaxial cable with thin structure. An example enables to integrate also high speed busses such as USB, HDMI etc. The flexible printed wire boards can be replaced with the integrated multilayer structure. An electrically shielded structure is possible to implement. An example may have a possibility to reduce critical antenna transmission and matching losses. This may be achieved by having an ability to implement multi-section quarter wave transmission line transformers into the unibody.

An example leads to much smaller overall size of the product than when implementing the product using the coaxial cables or traditional microstrip lines or strip lines on the PWB. In an example a wide frequency bandwidth can be achieved in a compact size.

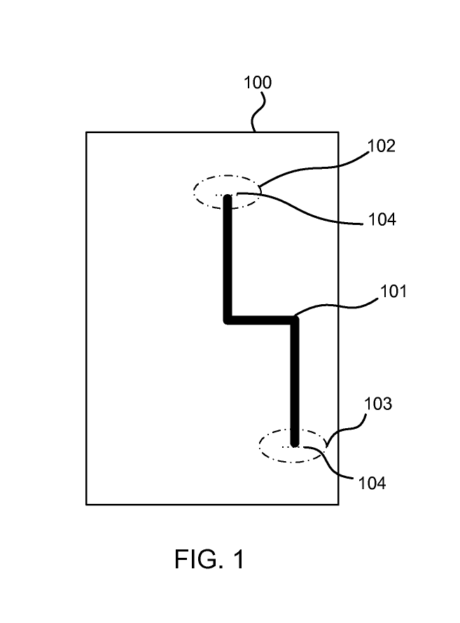

FIG. 1 shows a body 100 of a mobile apparatus having a multilayer high frequency signal line 101. The multilayer high frequency signal line 101 may be alternatively referred to as a multilayer high frequency signal line structure. The line 101 connects two end points 102, 103. The end points 102,103 may be connection points having an interface 104 for high frequency signals. The interfaces 104 may be connected to high frequency signal hardware, for example receiver, transceiver, antenna, high speed USB blocks, physical high data speed interfaces, etc. In an example, the body 100 may be a unibody of the mobile apparatus. In a unibody (also referred to as unit body, unitary construction, or unitized construction) design, the frame of the mobile apparatus and the body of the mobile apparatus are constructed as a single unit. In an example, the body 100 comprises a cover of the mobile apparatus. For example a back cover. In another example, the body 100 may be a frame of the mobile apparatus, for example a chassis. The body 100 may be non-conductive material, for example plastic or composite material. The body 100 may also be conductive material, for example metal, aluminum, etc. The material depends on the design of the mobile apparatus. The multilayer high frequency signal line 101 is configured to conform to the shape of the body 100. For example three dimensional shape of the body 100 may be conformed in all planes, x, y and z. Consequently, the high frequency signal can be conveyed inside the mobile apparatus, even from the top to the bottom of the mobile apparatus, without using the scarce space of the PWB.

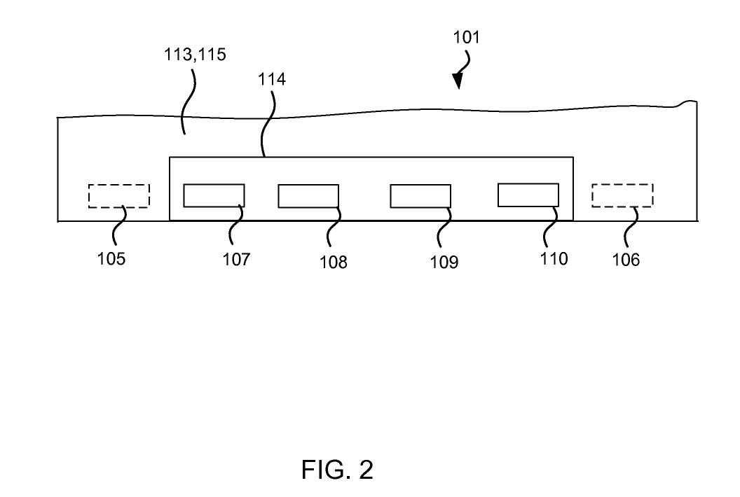

FIG. 2 illustrates a cross section of a multilayer high frequency signal line structure. The multilayer high frequency signal line 101 is shown in a cross section. A conductive layer 113,115 is encapsulating a dielectric layer 114. In the example, the conductive layer 115 is also a ground layer for the line 101. Theoretical grounds 105, 106 are shown by dashed boxes in FIG. 2, naturally the whole conducive layer 113,115 is configured to act as the ground. Signal lines 107,108,109,110 are shown in FIG. 2. They are encapsulated by the dielectric layer 114. The number of signal lines 107,108,109,110 may vary, and four lines are only depicted as an illustrative example.

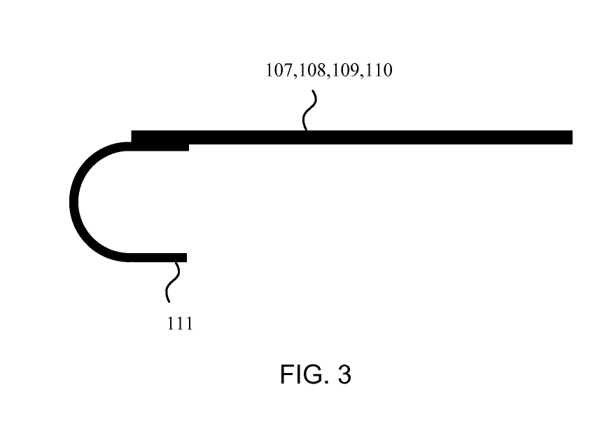

FIG. 3 illustrates a connection 111 of the line 101 in accordance with an illustrative example. In the example of FIG. 3 the connection comprises a spring contact. This may be in form of a C-clip. For example, the spring contact may be used on PWB. It can be used for electric contacts to a main PWB. The connection 111 is connected to the multilayer high frequency signal line 101, for example to the signal lines 107,108,109,110. The connection 111 may be under the signal line. As another example of the connection 111, a pogo pin may be used as a contact pin, instead of the C-clip. The connection 111 can be used while assembling the mobile apparatus, for example so that when the body 100 is attached, the connection 111 couples the line 101 to the PWB, where desired.

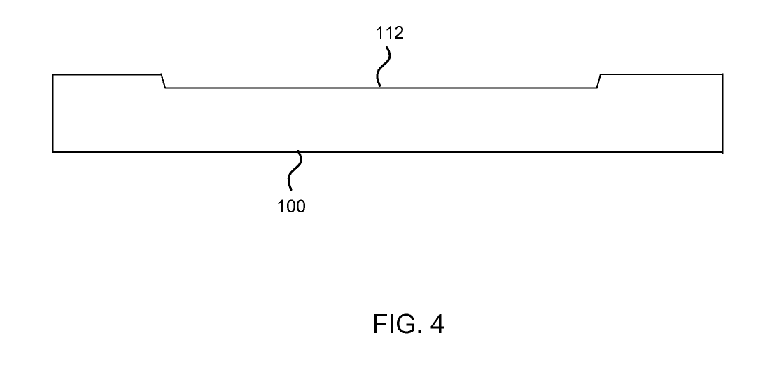

FIG. 4 illustrates a manufacturing process, in accordance with an illustrative example. FIG. 4 shows a body 100. In the example the body 100 comprises non-conductive material. For example plastic or composite material. A groove 112 is manufactured on the body 100. The groove 112 manufacturing may be based on molding. The groove 112 may also be carved on the body 100. Precision manufacturing tools are used. The groove 112 depth is approximately 20 μm (micrometer).

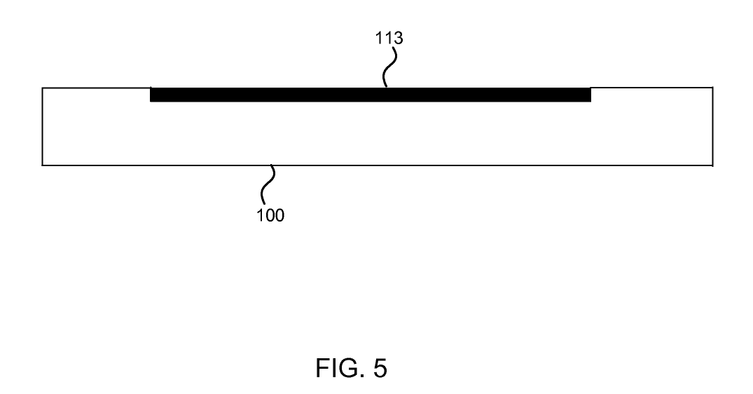

FIG. 5 illustrates a manufacturing process, in which a first conductive layer 113 is dispensed. The first conductive layer 113 may be configured as a ground layer for the multilayer high frequency signal line 101. A dispensed material may be silver particles. Any other metal or metal alloy with a good conductivity may be used, for example copper particles. A thickness of the conductive layer 113 is approximately 20 μm. For example, the first conductive layer 113 fits into the groove 112. There are various ways of dispensing the first conductive layer 113. It may be printed, for example aerosol jet printing may be applied, etc. A curing process follows the dispensing process. A curing temperature is low enough so that the temperature is below a deformation point of the material of the body 100, for example below a deformation point of the plastic. For example, maximum used curing temperature is 110 C.

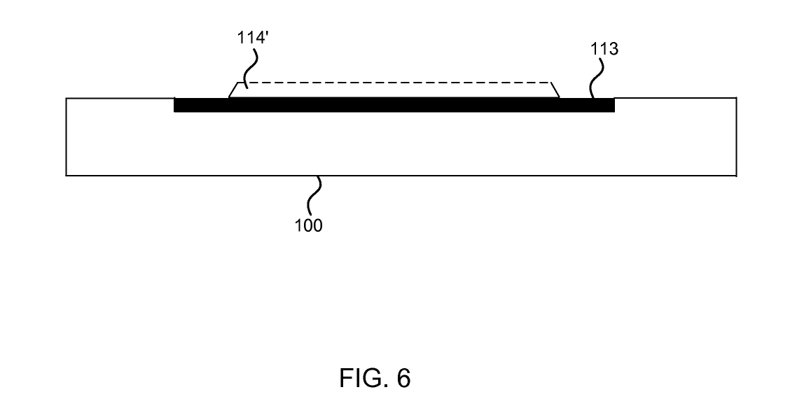

FIG. 6 illustrates a manufacturing process, in which a first dielectric layer 114′ is dispensed. The first dielectric layer 114′ may be configured for the multilayer high frequency signal line 100. The first dielectric layer 114′ may be dispensed on the first conductive layer 113. A dielectric material is applied. A thickness of the first dielectric layer 114′ is approximately 200 μm. There are various ways of dispensing the first dielectric layer 114′. It may be printed, aerosol jet printing may be applied, etc. A curing process follows the dispensing process. A fast curing may be applied by ultra violet radiation emission.

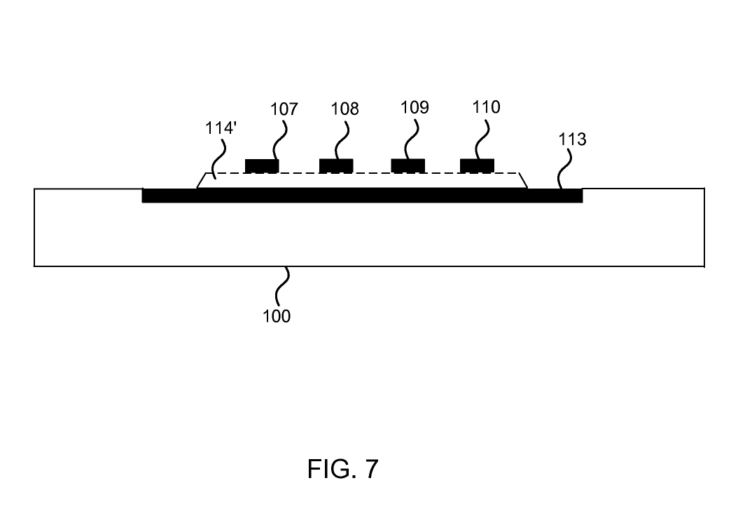

FIG. 7 illustrates a manufacturing process, in which signal lines 107, 108, 109, 110 are being printed. Aerosol jet printing may be used as a manufacturing process. For another example, also in the case of very thin signal lines, ink jet printing may also be applied. The signal lines 107, 108, 109, 110 may be configured as the signal lines for the multilayer high frequency signal line 101. The signal lines 107, 108, 109, 110 are dispensed on the first dielectric layer 114′. A dispensed material may be silver particles. Any other metal or metal alloy with a good conductivity may be used, for example copper particles. A thickness of the signal lines 107, 108, 109, 110 is approximately 20 μm. In the example of FIG. 7 four separate signal lines are printed. A curing process follows the dispensing process. A curing temperature is low enough so that the temperature is below a deformation point of the first dielectric layer 114′, for example below a deformation point of the dielectric material. For example, maximum used curing temperature is 110 C. In the example, the silver particles melt enough to establish the conductivity for the signal lines, however the temperature is low enough not to cause the deformation of the dielectric material.

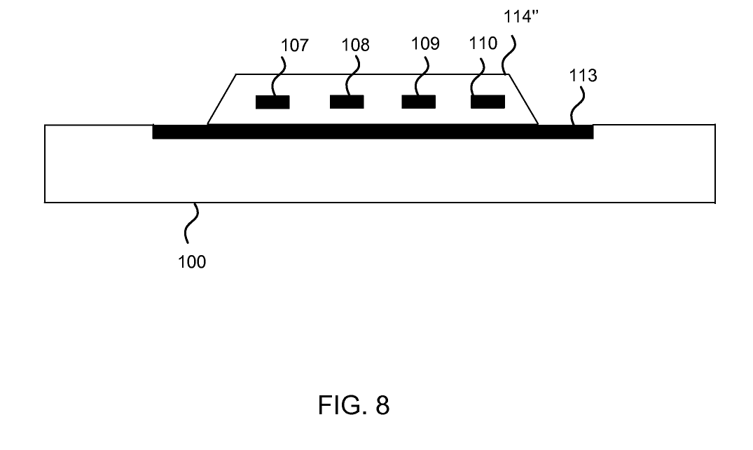

FIG. 8 illustrates a manufacturing process, in which a second dielectric layer 114″ is dispensed. The second dielectric layer 114″ may be configured for the multilayer high frequency signal line 101. The second dielectric layer 114″ is dispensed on the first dielectric layer 114′ and on the signal lines 107, 108, 109, 110. A dielectric material is applied. A thickness of the second dielectric layer 114″ is approximately 220 μm. There are various ways of dispensing the second dielectric layer 114″. It may be printed, aerosol jet printing may be applied, etc. A curing process follows the dispensing process. A fast curing may be applied by ultra violet radiation emission. The dispensed first and the second dielectric layer 114′ and 114″ encapsulate the signal lines 107,108,109, and 110.

The first and the second dielectric layers 114′, 114″ are configured establish a unified dielectric layer after they have been dispensed and cured. The unified dielectric layer 114′, 114″ encapsulates the signal lines 107,108,109, and 110.

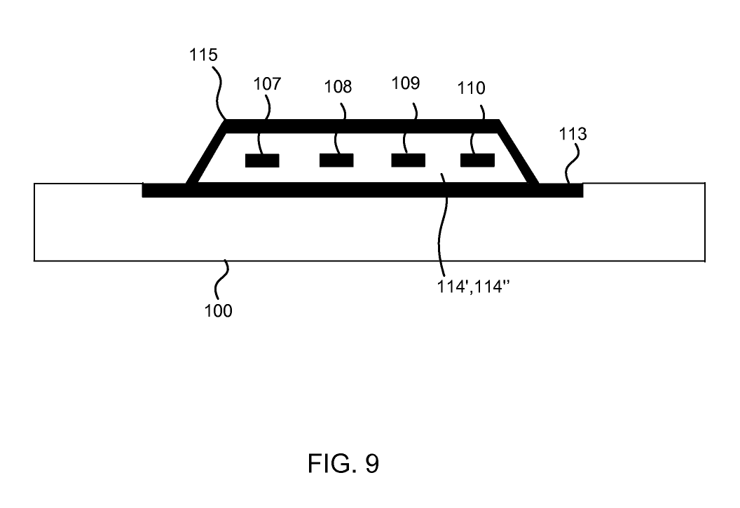

FIG. 9 illustrates a manufacturing process, in which a second conductive layer 115 is dispensed. The second conductive layer 115 may be configured as a ground layer for the multilayer high frequency signal line 101. The second conductive layer 115 is dispensed on the second dielectric layer 114″ on and on the first conductive layer 113. A dispensed material may be silver particles. Any other metal or metal alloy with a good conductivity may be used, for example copper particles. A thickness of the second conductive layer 115 is approximately 20 μm. There are various ways of dispensing the second conductive layer 115. It may be printed, aerosol jet printing may be applied, etc. A curing process follows the dispensing process. A curing temperature is low enough so that the temperature is below a deformation point of the body 100, for example below a deformation point of the plastic. For example, maximum used curing temperature is 110 C.

The first and the second conductive layers 113, 115 are configured to establish the ground for the line 100. The first and the second conductive layers 113, 115 encapsulate the dielectric layer 114. The first and the second conductive layers 113, 115 are configured to establish a shield for the lines 100. For example, an electrical shield can be established for high frequency signals.

An overall height of the manufactures line 101 as shown in FIG. 9 may be relatively thin. For example in a range of 400 μm to 600 μm, preferably less than 500 μm. Consequently, the line 100 can be manufactured to pass via various different structures of the body 100, to conform the three dimensional shape of the body 100.

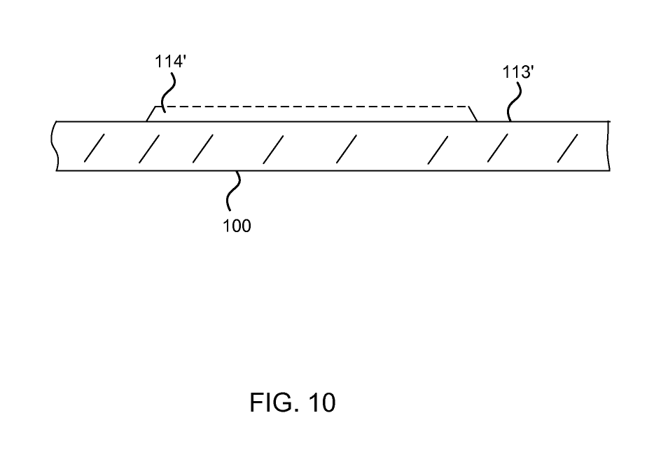

An example of the manufacturing process in FIGS. 10-13 illustrates similar example than in FIGS. 4-9. However, in the example of FIGS. 10-13 the body 100 comprises a conductive material, instead of the non-conductive material of FIGS. 4-9.

FIG. 10 illustrates a manufacturing process, in which a first dielectric layer 114′ is dispensed. In the example of FIG. 10 the first dielectric layer 114′ is dispensed directly on the body 100. The body 100 is conductive material, for example metal. The conductive body 113′ is configured to establish the ground layer for the multilayer high frequency signal line 100.

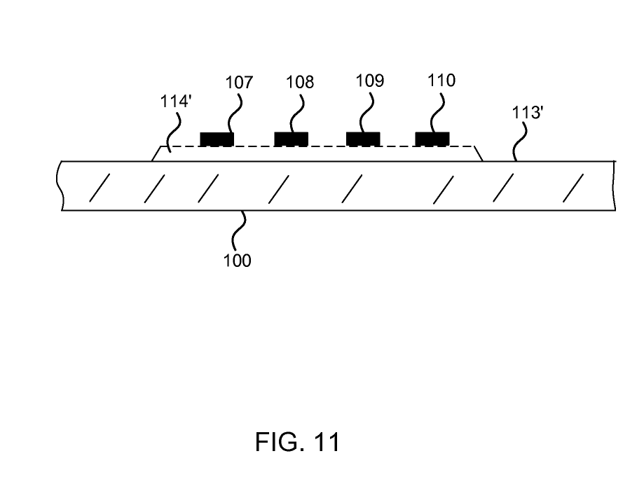

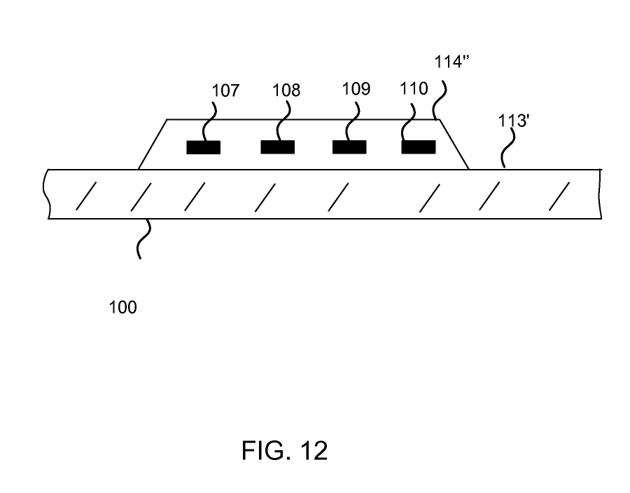

FIGS. 11 and 12 are similar than FIGS. 7, 8.

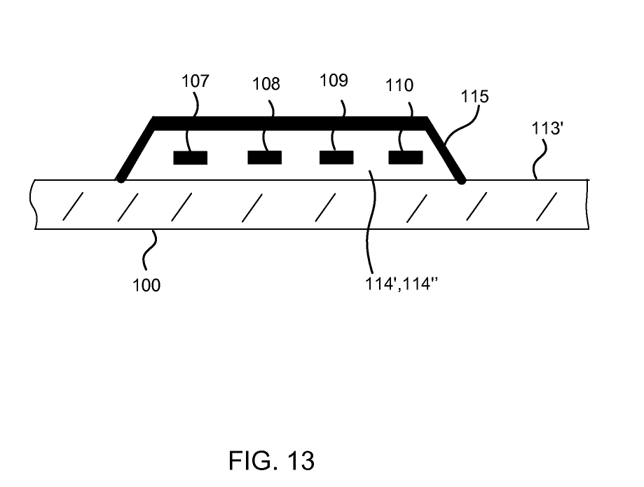

FIG. 13 is similar to FIG. 9. However, in the example of FIG. 13, the conductive body 113′ is connected to the conductive layer 115. The ground of the multilayer high frequency signal line 101 is established by the conductive layer 115 and the conductive body 113′. The conductive layer 115 and the conductive body 113′ encapsulates the dielectric layer 114′,114″.

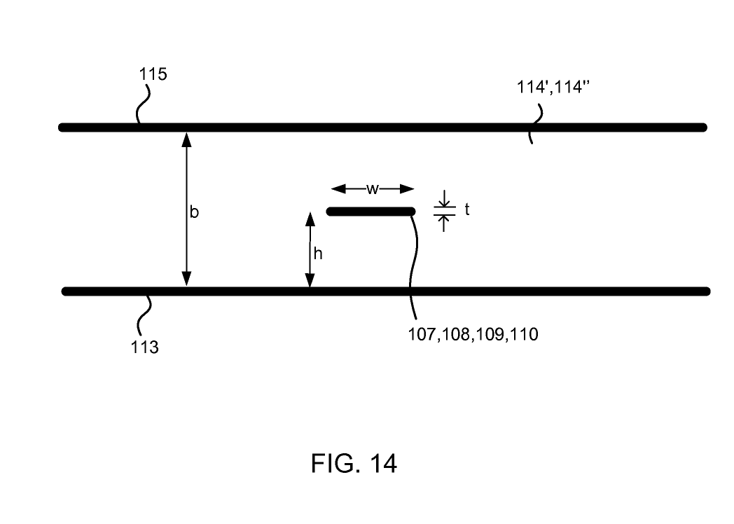

FIG. 14 illustrates a cross section of a multilayer high frequency signal line structure. The multilayer high frequency signal line 101 is shown in a cross section. The example of FIG. 14 illustrates dimensions of the elements of the multilayer high frequency signal line 101. A line width, w, of the signal line 107,108,109,110 may be 200 μm. Manufacturing tolerances may be + or −20 μm, for example. Material of the signal line maybe based on silver. An aerosol jet printing, for example, a process of Optomec may be used as a manufacturing process. A layer thickness, t, may be 20 μm. Manufacturing tolerances may be + or −2 μm, for example. Material of the signal line maybe based on silver.

Programmable layer thickness may in in the range of 10-20 μm. For example the manufacturing process enables 10 μm and another manufacturing process enables 20 μm layer. A dielectric height, h, may be 200 μm. The layer height may be variable. Ground layers, b, may be 420 μm. Manufacturing tolerances may be + or −20 μm, for example. The ground layers, b, is based on the total dielectric height. Consequently, equation h=(b-t)/2 and w/b=constant may be used for scaling the structure. Ground layer thickness may be 20 μm. Grounding can also be variable starting from >10 μm. If pad printing is used, layer can also be 10 μm. Silver or copper may be used as materials. The following losses may be with silver at 2 GHz frequency signal, the conductivity being 40% of bulk silver; 5.88-6.21 dB/m. Process parameters can be adjusted according to the most optimum performance.

Technology options to be used may be varied for material deposition methods and options. Printed electronics by using nano-ink materials, for example Dimatix, and Pixdro. An aerosol jet printing technology developed by Optomec or Neotec. Ink jet printing technology and evaporation printing. A direct-write material deposition, for example by nScrypt. A pad printing by Tampo. Curing or sintering methods. An UV light. A thermal treatment. A photonic sintering. A Xenon flash or a laser beam. The process can be automated.

Printed electronics is a set of printing methods used to create electrical devices on various substrates. Printing typically uses common printing equipment suitable for defining patterns on material, such as screen printing, flexography, gravure, offset lithography, and inkjet. By electronic industry standards, these are low cost processes. Electrically functional electronic, atomic or optical inks are deposited on the substrate, creating active or passive devices, such as thin film transistors or resistors. Printed electronics may facilitate very low-cost electronics for various applications.

Aerosol jet printing (also known as a maskless mesoscale materials deposition or M3D) is another material deposition technology for printed electronics. The aerosol jet process begins with atomization of an ink, which can be heated up to 80° C., producing droplets on the order of one to two micrometres in diameter. The atomized droplets are entrained in a gas stream and delivered to the print head. Here, an annular flow of clean gas is introduced around the aerosol stream to focus the droplets into a tightly collimated beam of material. The combined gas streams exit the print head through a converging nozzle that compresses the aerosol stream to a diameter as small as 10 μm. The jet of droplets exits the print head at high velocity (-50 meters/second) and impinges upon the substrate. Electrical interconnects, passive and active components may be formed by moving the print head, equipped with a mechanical stop/start shutter, relative to the substrate. The resulting patterns can have features ranging from 10 μm wide, with layer thicknesses from tens of nanometers to >10 μm. A wide nozzle print head enables efficient patterning of millimeter size electronic features and surface coating applications. All printing occurs without the use of vacuum or pressure chambers and at room temperature. The high exit velocity of the jet enables a relatively large separation between the print head and the substrate, typically 2-5 mm. The droplets remain tightly focused over this distance, resulting in the ability to print conformal patterns over three dimensional substrates. Despite the high velocity, the printing process is gentle; substrate damage does not substantially occur and there is generally no general splatter or overspray from the droplets. Once patterning is complete, the printed ink typically requires post treatment to attain final electrical and mechanical properties. Post-treatment is driven more by the specific ink and substrate combination than by the printing process. A wide range of materials has been successfully deposited with the aerosol jet process, including diluted thick film pastes, thermosetting polymers such as UV-curable epoxies, and solvent-based polymers like polyurethane and polyimide, and biologic materials.

While examples have been discussed in the form of a smartphone, as discussed other high frequency computing devices may be used equivalently, such as tablet computers, netbook computers, laptop computers, desktop computers, processor-enabled televisions, personal digital assistants (PDAs), touchscreen devices connected to a video game console or set-top box, or any other computing device that has a high frequency shielded signal line 101 and is enabled to apply it.

The term ‘computer’, ‘computing-based device’, ‘apparatus’ or ‘mobile apparatus’ is used herein to refer to any device with processing capability such that it can execute instructions. Those skilled in the art will realize that such processing capabilities are incorporated into many different devices and therefore the terms ‘computer’ and ‘computing-based device’ each include PCs, servers, mobile telephones (including smart phones), tablet computers, set-top boxes, media players, games consoles, personal digital assistants and many other devices.

The manufacturing methods and functionalities described herein may be operated by software in machine readable form on a tangible storage medium e.g. in the form of a computer program comprising computer program code means adapted to perform all the functions and the steps of any of the methods described herein when the program is run on a computer and where the computer program may be embodied on a computer readable medium. Examples of tangible storage media include computer storage devices comprising computer-readable media such as disks, thumb drives, memory etc. and do not include propagated signals. Propagated signals may be present in a tangible storage media, but propagated signals per se are not examples of tangible storage media. The software can be suitable for execution on a parallel processor or a serial processor such that the method steps may be carried out in any suitable order, or simultaneously.

This acknowledges that software can be a valuable, separately tradable commodity. It is intended to encompass software, which runs on or controls “dumb” or standard hardware, to carry out the desired functions. It is also intended to encompass software which “describes” or defines the configuration of hardware, such as HDL (hardware description language) software, as is used for designing silicon chips, or for configuring universal programmable chips, to carry out desired functions.

Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Alternatively, or in addition, the functionally described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc.

Any range or device value given herein may be extended or altered without losing the effect sought. Also any example may be combined to another example unless explicitly disallowed.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The steps of the methods described herein may be carried out in any suitable order, or simultaneously where appropriate. Additionally, individual blocks may be deleted from any of the methods without departing from the spirit and scope of the subject matter described herein. Aspects of any of the examples described above may be combined with aspects of any of the other examples described to form further examples without losing the effect sought.

The term ‘comprising’ is used herein to mean including the method, blocks or elements identified, but that such blocks or elements do not comprise an exclusive list and a method or apparatus may contain additional blocks or elements.

It will be understood that the above description is given by way of example only and that various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from the spirit or scope of this specification.

1. A manufacturing method, comprising:
dispensing a first dielectric layer on a ground layer, wherein the first dielectric layer is dispensed on a three dimensional portion of a body of an apparatus configured to high frequency signals;
jet printing at least one signal line directly on the first dielectric layer, wherein the at least one signal line is configured to the high frequency signals;
dispensing a second dielectric layer to encapsulate the at least one signal line; and
dispensing a conductive layer on the second dielectric layer and partly on the first dielectric layer so that the conductive layer is connected to the ground layer in order to encapsulate both the first dielectric layer and the second dielectric layer.

2. The manufacturing method of claim 1, wherein the ground layer, the first dielectric layer, the signal line, the second dielectric layer, and the conductive layer is configured to establish a shielded multilayer signal line structure for communications based on the high frequency signals.

3. The manufacturing method of claim 1, wherein all layers and the signal line are configured to conform to a shape of the three dimensional portion of the body, wherein the shape has dimensions in x, y and z plane.

4. The manufacturing method of claim 2, wherein a height of the shielded multilayer signal line structure from a surface of the body is in a range between 0.4 mm to 0.6 mm.

5. The manufacturing method of claim 1, further comprising:
dispensing the ground layer directly on the three dimensional portion, wherein the ground layer comprises conductive material;
wherein the three dimensional portion comprises non-conductive material, plastic or composite material; and
wherein the first dielectric layer is dispensed directly on the ground layer.

6. The manufacturing method of claim 5, further comprising:
creating a groove on the three dimensional portion; and
wherein the ground layer is dispensed on the groove.

7. The manufacturing method of claim 1, wherein the three dimensional portion comprises a conductive material or metal, and wherein the three dimensional portion comprises the ground layer; and
the dielectric layer is dispensed directly on the three dimensional portion.

8. The manufacturing method of claim 1, wherein the body comprises a unibody of the apparatus.

9. The manufacturing method of claim 1, wherein the body comprises a cover of the apparatus, and the dielectric layer is dispensed inside of the apparatus on the cover.

10. The manufacturing method of claim 1, wherein a ratio between a width of the signal line and a total height of the first and the second dielectric layer comprises 1:2.

11. The manufacturing method of claim 1, further comprising:
curing the first and the second dielectric layers by ultra violet radiation.

12. The manufacturing method of claim 1, further comprising:
curing the signal line at a low temperature.

13. The manufacturing method of claim 12, wherein the low temperature comprises maximum 110 degrees of Celsius.

14. The manufacturing method of claim 1, wherein the jet printing comprises aerosol jet printing or ink jet printing.

15. The manufacturing method of claim 1, wherein a material for the jet printing comprises silver particles.

16. The manufacturing method of claim 1, wherein the apparatus comprises a mobile apparatus.

17. The manufacturing method of claim 1, further comprising:
soldering a connection at an end of the at least one signal line, wherein the connection is configured to connect the signal line to a printed circuit board of the apparatus.

18. The manufacturing method of claim 1, wherein the manufacturing steps of dispensing a first dielectric layer, dispensing a second dielectric layer, and dispensing a conductive layer are based on printable electronics.

19. A shielded multilayer high frequency signal line structure, comprising:
a first dielectric layer dispensed on a ground layer, wherein the first dielectric layer is dispensed on a three dimensional portion of a body of an apparatus configured to high frequency signals, and wherein the shielded multilayer high frequency signal line structure is configured into the apparatus;
at least one signal line, which is configured jet printed directly on the first dielectric layer, wherein the at least one signal line is configured to the high frequency signals;
a second dielectric layer dispensed to encapsulate the at least one signal line; and
a conductive layer dispensed on the second dielectric layer and partly on the first dielectric layer so that the conductive layer is connected to the ground layer in order to encapsulate both the first dielectric layer and the second dielectric layer.

20. A mobile apparatus, comprising:
a first dielectric layer dispensed on a ground layer, wherein the first dielectric layer is dispensed on a three dimensional portion of a body of the mobile apparatus configured to high frequency signals;
at least one signal line, which is configured jet printed directly on the first dielectric layer, wherein the at least one signal line is configured to the high frequency signals;
a second dielectric layer dispensed to encapsulate the at least one signal line; and
a conductive layer dispensed on the second dielectric layer and partly on the first dielectric layer so that the conductive layer is connected to the ground layer in order to encapsulate both the first dielectric layer and the second dielectric layer.
